(19) United States
(12) Patent Application Publication
(10) Pub. No.: US 2015/0282613 A1
(43) Pub. Date: Oct. 8, 2015

(54) Shelving System Having Improved Structural Characteristics

(71) Applicant: Protrend Co., Ltd., Taipei City (TW)

(72) Inventor: Shun-Yi Chen, Taipei City (TW)

(73) Assignee: Protrend Co., Ltd., Taipei City (TW)

(21) Appl. No.: 14/244,653

(22) Filed: Apr. 3, 2014

(51) Int. Cl. A47B 55/00; B60B 33/00; A47B 57/34; A47B 96/02

(52) U.S. Cl. CPC A47B 55/00; A47B 96/021; B60B 33/0026; A47B 57/34

(57) ABSTRACT

A shelving system having improved structural characteristics. The shelving system comprises at least three weight-supporting crossbeams and at least three continuously tubular, V-shaped crossbeam-supporting posts. The at least three weight-supporting crossbeams have a substantially vertical outer shoulder and substantially horizontal inner reinforcement flange positioned along the substantially vertical outer shoulder, upon which a shelf may be placed such that the shelf is supported by at least two of the at least three weight-supporting crossbeams.

### FIELD OF THE DISCLOSURE

The present description relates generally to shelving systems for storing items, and more particularly to a shelving system having improved structural characteristics.

### BACKGROUND OF THE INVENTION

Shelving systems are generally known in the art. In particular, shelving systems comprised of crossbeams and crossbeam-supporting posts that support shelves for storing items are well known. Among other things, crossbeams may provide structural rigidity to the shelving system. Many shelving systems include four crossbeam-supporting posts, attached via crossbeams, that are organized such that they form the four corners of a rectangle when viewed from above.

Various crossbeam designs or profiles are also known in the art. The specific crossbeam profile design may contribute to the rigidity and/or strength of the shelving system as well as to the amount of deflection of the crossbeam under the load of the shelf (and any items placed onto the shelf). However, crossbeam profiles that provide favorable rigidity, strength, and deflection characteristics often require the use of multiple flanges to support the load of the shelf (and any items placed onto the shelf). Such prior art crossbeams that require the use of two or more flanges are generally not invertible, that is to say, they cannot be inverted and still properly function as part of the same shelving system.

For example, U.S. Pat. Nos. 7,128,225 and 7,252,202 disclose several such multi-flange crossbeams. These crossbeams, though they purportedly provide favorable strength, rigidity, and deflection characteristics for the crossbeam and shelving system, may not be invertible, and therefore may suffer from several shortcomings. First, if, due to assembler error, one or more crossbeams of a shelving system are assembled upside down unbeknownst to the assembler, then the assembler may need to dissemble a significant portion of the shelving system to correct the mistake. An assembly error such as this may take a significant amount of time to correct. Even more problematic, if the mistake is not corrected prior to loading the shelving system, failure can occur, which can result in damage to the items stored on the shelving system and/or potential bodily injury to anyone near the shelving system when the failure occurs. Second, without an invertible crossbeam, any particular crossbeam design has only a single function, e.g., supporting a shelf or acting as a tray, with edges, to hold objects, but not both.

An invertible crossbeam having a single flange can overcome both of these shortcomings. A shelf may be placed on a single flange, invertible crossbeam on either side of the flange because there is no second flange that would restrict or prevent proper seating of the shelf on the flange when the crossbeam is inverted.

If, on one hand, the single flange is located equidistant from the top and the bottom of the crossbeam, then the orientation of the crossbeam in the shelving system is immaterial, i.e., the assembler cannot incorrectly orient the crossbeam in the shelving system.

If, on the other hand, the single flange is eccentrically spaced from the top and the bottom of the crossbeam, then the two different orientations of the crossbeam, when assembled, results in different functionality. For example, if the flange is orientated such that it is near the top of the crossbeam, and the shelf is of sufficient thickness such that it rests flush with the top of the crossbeam or protrudes above the top of the crossbeam, then any items placed on the shelf can be easily slid off of the shelf and away from the shelving system without first having to lift the item above the top of the crossbeam before moving the item away from the shelving system. Some articles may be desired to be placed on a shelf without first having to lift the article above the top of the crossbeam. Others may be preferred to be contained within the upright edges of a tray formed by the shelf and the supporting beam itself. Indeed, if the flange is orientated such that it is near the bottom of the crossbeam, and the shelf is of a thickness such that it rests below the top of the crossbeam, then the shelf-crossbeam combination acts as a storage tray that prevents items from falling off of the shelf and away from the storage unit. Ball bearings, or other round or unstable objects are perhaps suitable items to store in a shelving system with the crossbeam orientated such that it and the shelf act as a storage tray.

Although a single flange, invertible crossbeam design may provide the aforementioned benefits, the crossbeam must also have sufficient strength, rigidity, and deflection characteristics such that the crossbeam does not fail under a load. By using two layers of material for the flange, i.e., a dual-thickness flange, the crossbeam retains the desirable characteristics associated with invertibility, as well as the necessary structural integrity to operate safely and as intended without the risk of failure. Accordingly, there is a need for an invertible crossbeam having only one flange, but that still exhibits favorable strength, rigidity, and deflection characteristics.

Crossbeam-supporting posts for shelving systems are also known in the art. Such crossbeam-supporting posts, however, are generally comprised of a layer of material bent at an angle (usually 90 degrees) along a vertical axis of the crossbeam-supporting posts. Such single layer, crossbeam-supporting posts are often not strong enough to handle heavy loads that shelving systems, and commercial shelving systems in particular, must bear.

Accordingly, a second layer of material is sometimes used to provide additional structural support for the crossbeam-supporting post. However, when a second layer of material is used, it is often pressed directly against the first layer of material and does not traverse, or return, over the entire cross-section of the crossbeam-supporting post. Thus, the crossbeam-supporting post cross-section does not form a continuously tubular, crossbeam-supporting post periphery.

In this way, such partial, dual-layer crossbeam-supporting post designs suffer from several shortcomings. First, when the second layer of material does not traverse the entire cross-section of the crossbeam-supporting post, only limited rigidity and strength benefits are obtained. In particular, the enhanced strength and rigidity benefits of having a second layer of material will be realized only to the extent that a load placed on the crossbeam-supporting post is borne by that very portion of the crossbeam-supporting post having two layers of material. Having a continuously tubular crossbeam-supporting post (i.e., a second layer of material that traverses the entire cross-section of the post) imparts favorable strength, rigidity, and deflection characteristics to the post and to the shelving system. Second, when the second layer of material is positioned directly against the first layer of material, there is no closed cavity in the crossbeam-supporting post to accommodate the insertion of crossbeam pegs or rivets, casters, levelers, post couplers, or other inserts to permit movement of the shelving system after assembly, leveling of the shelving system to accommodate an uneven floor, etc. The existence of the closed cavity also results in a crossbeam-supporting post cross-section geometry having favorable strength, rigidity, and deflection characteristics.

Thus, there is a need for a continuously tubular crossbeam-supporting post having favorable strength, rigidity, and deflection characteristics that can accommodate the insertion and isolation of pegs, levelers or other insert.

While the background shelving systems identified herein generally work for their intended purpose, the subject invention provides several improvements thereto, particularly by a shelving system having improved structural characteristics described and claimed herewithin.

### BRIEF SUMMARY OF THE INVENTION

A shelving system includes at least three weight-supporting crossbeams. Each of the at least three weight-supporting crossbeams have two opposed ends and are capable of being positioned substantially parallel to a supporting surface to form a polygonal shape amongst the at least three weigh-supporting crossbeams once the ends are operably adjoined in succession in aligned beam support posts. Each of the at least three weight-supporting crossbeams has one or more beam attachment members for mated affixation to the aligned beam support posts. The aligned beam support posts include at least three continuously tubular, V-shaped crossbeam-supporting posts that emanate upwardly from the supporting surface. Each of the at least three continuously tubular, V-shaped crossbeam-supporting posts are positioned at adjoining ends of the respective opposed ends of at least two of the at least three weight-supporting crossbeams. In the preferred embodiment, each of the continuously tubular, V-shaped crossbeam-supporting posts are oriented substantially perpendicular to the supporting surface and to each of the at least three weight-supporting crossbeams. The at least three continuously tubular, V-shaped crossbeam-supporting posts have one or more post attachment members for mated affixation to respective ones of the beam attachment members in the at least three weight-supporting crossbeams that enable the at least three weight-supporting crossbeams to operably and restrainably fasten to the at least three continuously tubular, V-shaped crossbeam-supporting posts.

In one preferred embodiment, the shelving system also includes at least one shelf supported in a position substantially parallel to the supporting surface by at least two of the at least three weight-supporting crossbeams.

In another preferred embodiment, each of the at least three weight-supporting crossbeams have a substantially vertical outer shoulder and a substantially horizontal inner reinforcement flange that is positioned along the substantially vertical outer shoulder.

In another preferred embodiment, the shelving system's at least one shelf rests on at least two of the substantially horizontal inner reinforcement flanges of at least two of the at least three weight-supporting crossbeams. These substantially vertical outer shoulders and horizontal inner reinforcement flanges operably and telescopically receive and support the at least one shelf.

In still another preferred embodiment of the invention, the substantially vertical outer shoulders and substantially horizontal inner reinforcement flanges of the adjoined weight-supporting crossbeams form a shelf retention cavity.

In a further preferred embodiment, the substantially horizontal inner reinforcement flange includes upper and lower horizontal flange segments connected by a vertical flange segment that form a flange channel.

In yet another preferred embodiment, the substantially horizontal inner reinforcement flange of each of the at least three weight-supporting crossbeams includes a dual-thickness, horizontal flange folded back on itself.

In another preferred embodiment, the at least three weight-supporting crossbeams can be installed on the post in an inverted orientation, yet remain restrainably attached to respective ones of the at least three continuously tubular, V-shaped crossbeam-supporting posts.

In another embodiment, the substantially horizontal inner reinforcement flanges are positioned equidistant from a top and a bottom of each of the at least three weight-supporting crossbeams. Alternatively, the substantially horizontal inner reinforcement flanges are positioned eccentrically from the top and the bottom of each of the at least three weight-supporting crossbeams to enable the inversion of same—to, in turn enable alternative shelf placement options, one with an edge and one without.

In other preferred embodiments, at least one of the at least three weight-supporting crossbeams comprises an indented, weight-supporting crossbeam.

In still other preferred embodiments, the shelf can be a substantially planar, solid shelf, a substantially planar grated shelf, a substantially planar slotted rack, and/or a substantially planar wire rack.

Amongst the preferred embodiments of upright post designs, each of the at least three continuously tubular V-shaped vertical crossbeam-supporting posts has a crimp that secures a first end and a second of each of the posts.

In another preferred embodiment, the shelving system includes four continuously tubular, V-shaped crossbeam-supporting posts.

In yet another preferred embodiment, each of the at least three continuously tubular, V-shaped crossbeam-supporting posts define a substantially closed cavity region having an uninterrupted peripheral cross-section.

Preferably, the one or more post attachment members of the shelving system comprise one or more multi-lobed keys, and the one or more beam attachment members are one or more pegs shaped and spaced for aligned insertion into respective ones of the one or more keys. The one or more pegs and the one or more keys enable the at least three weight-supporting crossbeams to be operably and restrainably fastened to the at least three continuously tubular, V-shaped crossbeam-supporting posts.

In yet additional preferred embodiments, the invention includes one or more leveler assemblies that can be inserted into one or more of the at least three continuously tubular, V-shaped crossbeam-supporting posts, at the bottom of the posts. Likewise, the invention includes post caps that can be inserted into the tops of the posts to close off their top tubular constructions. Further, the preferred embodiment of the invention includes one or more caster assemblies that can be inserted into one or more of the at least three continuously tubular, V-shaped crossbeam-supporting posts.

In yet another preferred embodiment, the invention includes one or more post couplings that are can be inserted into adjoining ones or more of the at least three continuously tubular, V-shaped crossbeam-supporting posts, in order to join successive supporting posts in the longitudinal direction.

In another preferred embodiment, a hook and notch assembly within one or more of the at least three continuously tubular, V-shaped crossbeam-supporting posts secures the peripheral shape of the continuously tubular, V-shaped crossbeam-supporting posts. Alternatively, one or more of the at least three continuously tubular, V-shaped crossbeam-supporting posts include a first exterior wall and a first interior wall, a second exterior wall and a second interior wall, an exterior corner connecting the first exterior wall with the second exterior wall, and an interior corner connecting the first interior wall with the second interior wall, in which one of the exterior corner and the interior corner is a welded corner.

In another preferred embodiment, one or more of the at least three continuously tubular, V-shaped crossbeam-supporting posts includes two post legs, each post leg having a width portion and a diagonal midpoint length portion. Preferably, the length portion to width portion ratio ranges from 4 to 6.

In another preferred embodiment, one or more of the at least three continuously tubular, V-shaped crossbeam-supporting posts includes two post legs, each post leg having a width portion and a diagonal midpoint length portion—in which the length portion to width portion ratio ranges from 4.5 to 5.5.

### BRIEF DESCRIPTION OF THE DRAWINGS

For a better understanding of the present disclosure, reference may be had to various examples shown in the attached drawings, in which:

FIG. 1 is a perspective view of one embodiment of shelving system conforming to the present invention.

FIG. 2 is a perspective view of one embodiment of weight-supporting crossbeam, as utilized in the invention.

FIG. 3 is an elevated front view of the weight-supporting crossbeam of FIG. 2

FIG. 4 is a top plan view of the weight-supporting crossbeam of FIG. 2.

FIG. 5 is a perspective view of another embodiment of weight-supporting crossbeam, as utilized in the invention.

FIG. 6 is an elevated front view of the weight-supporting crossbeam of FIG. 5.

FIG. 7 is a top plan view of the weight-supporting crossbeam of FIG. 5.

FIG. 8 is a perspective view of another embodiment of shelving system conforming to the present invention.

FIG. 9 is a perspective view of one embodiment of indented, weight-supporting crossbeam, as utilized in the invention.

FIG. 10 is a perspective view of the indented weight-supporting crossbeam of FIG. 9, inverted.

FIG. 11 is a perspective view of another embodiment of indented, weight-supporting crossbeam, as utilized in the invention.

FIG. 12 is a perspective view of a portion of a first embodiment of continuously tubular, V-shaped crossbeam-supporting post, as utilized with the invention.

FIG. 13 is a perspective view of a portion of a second embodiment of continuously tubular, V-shaped crossbeam-supporting post, as utilized with the invention.

FIG. 14 is a perspective view of a portion of a third embodiment of continuously tubular, V-shaped crossbeam-supporting post, as utilized with the invention.

FIG.15 is a perspective view of a portion of a fourth embodiment of continuously tubular, V-shaped crossbeam-supporting post, as utilized with the invention.

FIG. 16 is an enlarged elevated rear view of a portion of the weight-supporting crossbeam of FIG. 2.

FIG. 17 is a cross-sectional side view of the weight-supporting crossbeam of FIG. 16, taken along lines 17-17 of FIG. 16, and looking in the direction of the arrows.

FIG. 18 is an enlarged elevated rear view of a portion of the weight-supporting crossbeam of FIG. 5.

FIG. 19 is a cross-sectional side view of the weight-supporting crossbeam of FIG. 18, taken along lines 19-19 of FIG. 18, and looking in the direction of the arrows.

FIG. 20 is a perspective view of the weight-supporting crossbeam of FIG. 2 affixed to the continuously tubular, V-shaped crossbeam-supporting post of FIG. 12.

FIG. 21 is a top plan view of the weight-supporting crossbeam of FIG. 2 affixed to the continuously tubular, V-shaped crossbeam-supporting post of FIG. 12, as shown in FIG. 20.

FIG. 22 is a perspective view of the weight-supporting crossbeam of FIG. 5 affixed to the continuously tubular, V-shaped crossbeam-supporting post of FIG. 12.

FIG. 23 is a top plan view of the weight-supporting crossbeam of FIG. 5 affixed to the continuously tubular, V-shaped crossbeam-supporting post of FIG. 12, as shown in FIG. 22.

FIG. 24 is a perspective view of the weight-supporting crossbeam of FIG. 2 affixed to the continuously tubular, V-shaped crossbeam-supporting post of FIG. 13, as modified by moving the position of the crimp ninety degrees.

FIG. 25 is a top plan view of the weight-supporting crossbeam of FIG. 2 affixed to the continuously tubular, V-shaped crossbeam-supporting post of FIG. 13, as modified by moving the position of the crimp ninety degrees.

FIG. 26 is a perspective view of the weight-supporting crossbeam of FIG. 5 affixed to the continuously tubular, V-shaped crossbeam-supporting post of FIG. 13, as modified by moving the position of the crimp ninety degrees.

FIG. 27 is a top plan view of the weight-supporting crossbeam of FIG. 5 affixed to the continuously tubular, V-shaped crossbeam-supporting post of FIG. 13, as modified by moving the position of the crimp ninety degrees.

FIG. 28 is a perspective view of the weight-supporting crossbeam of FIG. 2 affixed to the continuously tubular, V-shaped crossbeam-supporting post of FIG. 14, as modified by moving the position of the hook and notch assembly ninety degrees.

FIG. 29 is a top plan view of the weight-supporting crossbeam of FIG. 2 affixed to the continuously tubular, V-shaped crossbeam-supporting post of FIG. 14, as modified by moving the position of the hook and notch assembly ninety degrees.

FIG. 30 is a perspective view of the weight-supporting crossbeam of FIG. 5 affixed to the continuously tubular, V-shaped crossbeam-supporting post of FIG. 14, as modified by moving the position of the hook and notch assembly ninety degrees.

FIG. 31 is a top plan view of the weight-supporting crossbeam of FIG. 5 affixed to the continuously tubular, V-shaped crossbeam-supporting post of FIG. 14, as modified by moving the position of the hook and notch assembly ninety degrees.

FIG. 32 is a perspective view of the weight-supporting crossbeam of FIG. 2 affixed to the continuously tubular, V-shaped crossbeam-supporting post of FIG. 15.

FIG. 33 is a top plan view of the weight-supporting crossbeam of FIG. 2 affixed to the continuously tubular, V-shaped crossbeam-supporting post of FIG. 15, as shown in FIG. 32.

FIG. 34 is a perspective view of the weight-supporting crossbeam of FIG. 5 affixed to the continuously tubular, V-shaped crossbeam-supporting post of FIG. 15.

FIG. 35 is a top plan view of the weight-supporting crossbeam of FIG. 5 affixed to the continuously tubular, V-shaped crossbeam-supporting post of FIG. 15, as shown in FIG. 34.

FIG. 36 is a perspective view of both the indented, weight-supporting crossbeam of FIG. 9 and the weight-supporting crossbeam of FIG. 2, inverted, affixed to the continuously tubular, V-shaped crossbeam-supporting post of FIG. 15.

FIG. 37 is a top plan view of both the indented, weight-supporting crossbeam of FIG. 9 and the weight-supporting crossbeam of FIG. 2, inverted, affixed to the continuously tubular, V-shaped crossbeam-supporting post of FIG. 15, as shown in FIG. 36.

FIG. 38 is a perspective view of both the indented, weight-supporting crossbeam of FIG. 10 and the weight-supporting crossbeam of FIG. 2 affixed to the continuously tubular, V-shaped crossbeam-supporting post of FIG. 15.

FIG. 39 is a top plan view of both the indented, weight-supporting crossbeam of FIG. 10 and the weight-supporting crossbeam of FIG. 2 affixed to the continuously tubular, V-shaped crossbeam-supporting post of FIG. 15, as shown in FIG. 38.

FIG. 40 is a perspective view of a substantially planar, solid shelf

FIG. 41 is a perspective view of a substantially planar, grated shelf.

FIG. 42 is a perspective view of a substantially planar, slotted rack.

FIG. 43 is a perspective view of a substantially planar, wire rack.

FIG. 44 is an elevated cross-sectional side view of the weight-supporting crossbeam of FIG. 2 (as shown in FIG. 17) in which the substantially planar, solid shelf of FIG. 40 is positioned in a first orientation.

FIG. 45 is an elevated cross-sectional side view of the weight-supporting crossbeam of FIG. 2, inverted, in which the substantially planar, solid shelf of FIG. 40 is positioned in a second orientation, so as to form an edge at the vertical portion of the crossbeam.

FIG. 46 is a perspective view of a post coupling for joining segments of continuously tubular, V-shaped crossbeam-supporting post.

FIG. 47 is a perspective view of a post cap.

FIG. 48 is a perspective view of the post cap of FIG. 47 inserted into a continuously tubular, V-shaped crossbeam-supporting post.

FIG. 49 is a perspective view of a leveler base cap.

FIG. 50 is a perspective view of a partially assembled leveler base cap assembly.

FIG. 51 is a perspective view of the leveler base cap assembly of FIG. 50, shown fully assembled.

FIG. 52 is a perspective view of a caster assembly for integration with the shelving system of the present invention.

### DETAILED DESCRIPTION

Reference will now be made in detail to the preferred embodiments of the invention, examples of which are illustrated in the accompanying drawings. While the invention will be described in conjunction with several preferred embodiments, the invention is intended to cover any and all alternatives, modifications and equivalents, which may be included within the spirit and scope of the invention, as defined by the claims. Furthermore, in the detailed description of the present invention, several specific details are set forth in order to provide a thorough understanding of the present invention. However, one of ordinary skill in the art would appreciate that the present invention may be practiced without all of these specific details. Thus, while the invention is susceptible to embodiment in many different forms, the subsequent description of the present disclosure should be considered only as an exemplification of the principles of the invention, one that is in no way intended to limit the invention to the embodiments so illustrated.

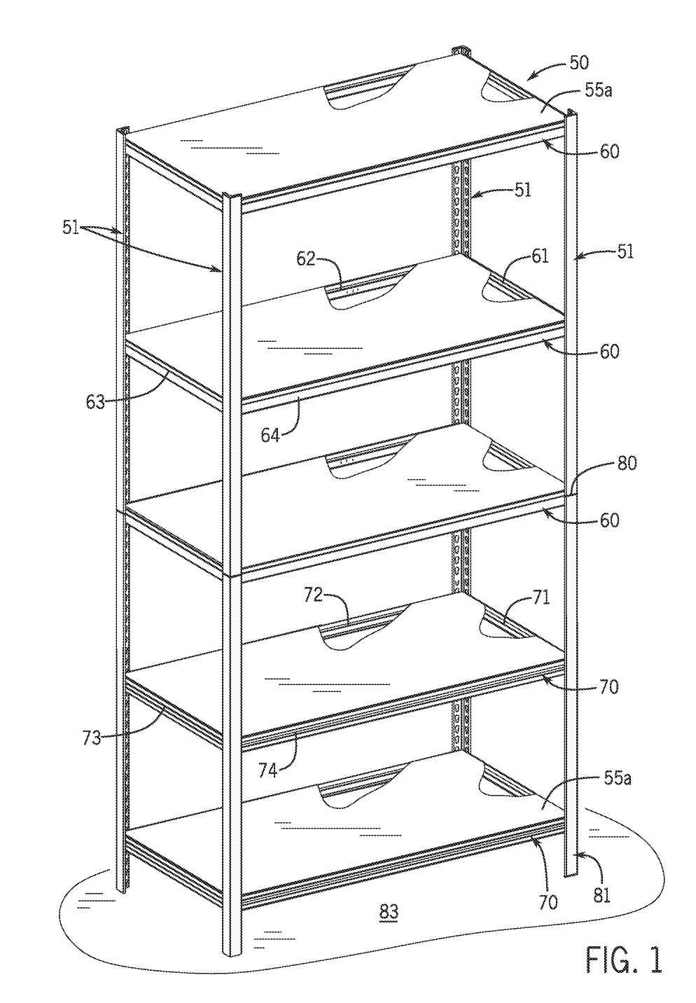

Referring to FIG. 1, shelving system 50 is shown including weight-supporting crossbeams 60, continuously tubular, V-shaped crossbeam-supporting posts 51, and shelves such as shelf 55a. Weight supporting crossbeams 60 comprise four distinct weight-supporting crossbeams 61, 62, 63, and 64. Each of continuously tubular, V-shaped crossbeam-supporting posts 51 is attached to multiple weight-supporting crossbeams 61, 62, 63, and 64, such that continuously tubular, V-shaped crossbeam-supporting posts 51 and weight-supporting crossbeams 61, 62, 63, and 64 form a shelving system into which shelves, such as shelf 55a may be inserted. Although shelving system 50 is shown as a rectangle, one of ordinary skill in the art will appreciate that alternative polygonal shapes are possible. Opposed ends of weight-supporting crossbeams 60 are operably adjoined in succession in aligned beam support posts, e.g., continuously tubular, V-shaped crossbeam-supporting posts 51, which are positioned at adjoining ends of those respective opposed ends. One of ordinary skill in the art will also understand that continuously tubular, V-shaped crossbeam-supporting posts 51 of varying sizes and shapes may be used and that a greater or fewer number of weight-supporting crossbeams 60 may be attached to the continuously tubular, V-shaped crossbeam-supporting posts 51 without the shelving system departing from the scope of the disclosure. Likewise, shelving system post segment 51 may be stacked on top of another shelving system post segment 81, having its own weight-supporting crossbeam 70, which includes individual weight-supporting crossbeams 71, 72, 73 and 74, to increase the height and storage capacity of the shelving system. Post coupling 80 may be used to join post segment 51 to post segment 81. Supporting surface 83 is positioned generally parallel to the weight-supporting crossbeams 60 and 70. Continuously tubular, V-shaped crossbeam-supporting posts 51 emanate upwardly from and substantially perpendicular to supporting surface 83.

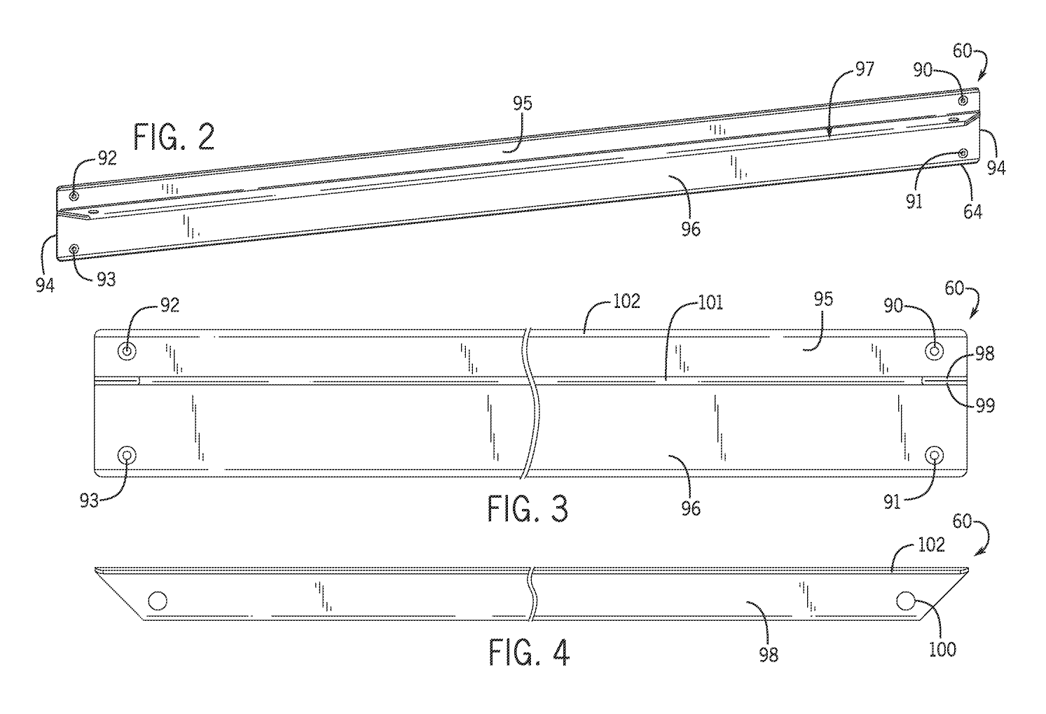

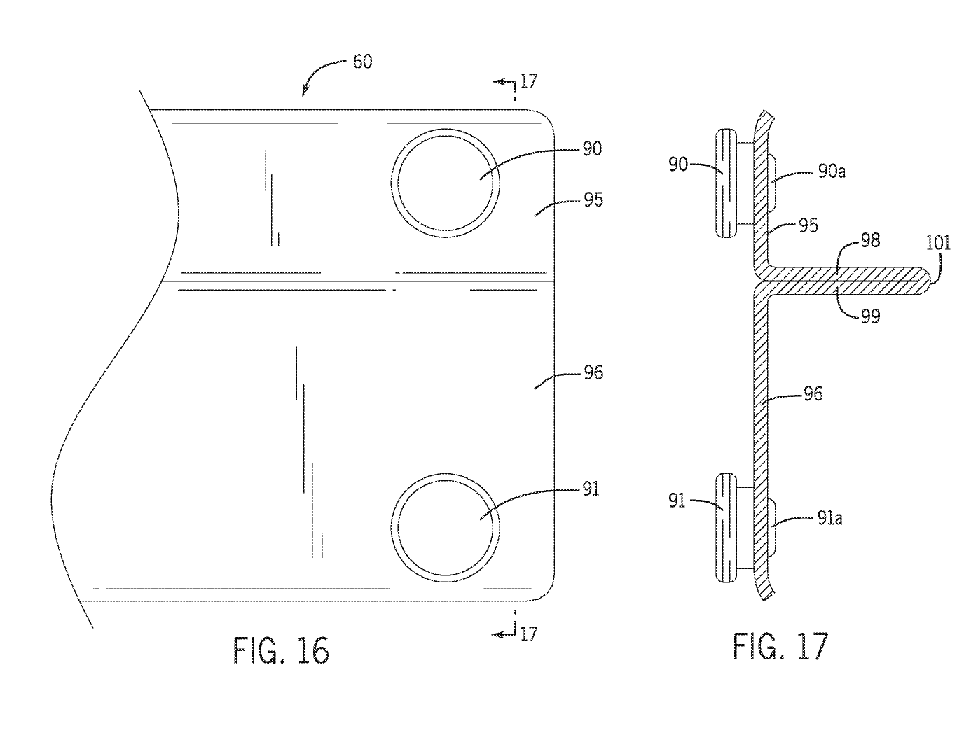

Referring now to FIGS. 2, 3, 4, 16, and 17, weight-supporting crossbeam 60 is shown. Weight-supporting crossbeam 60 has substantially horizontal inner reinforcement flange 97. Substantially horizontal inner reinforcement flange 97 is comprised of upper layer 98 and lower layer 99, resulting in a dual-thickness flange, folded back on itself. Upper layer 98 and lower layer 99 of substantially horizontal inner reinforcement flange 97 are connected via bend 101. The dual-thickness nature of substantially horizontal inner reinforcement flange 97 imparts favorable strength, rigidity, and deflection characteristics to weight-supporting crossbeam 60 and to the shelving system as a whole. Substantially horizontal inner reinforcement flange 97 of weight-supporting crossbeam 60 is positioned along a substantially vertical outer shoulder comprised of upper outer shoulder portion 95 and lower outer shoulder portion 96 of weight-supporting crossbeam 60, positioned between top 102 and bottom 64 of weight-supporting crossbeam 60. Substantially horizontal inner reinforcement flange 97 may be positioned anywhere along the substantially vertical outer shoulder of weight-supporting crossbeam 60. Further, the edges of substantially horizontal inner reinforcement flange 97 can be tapered to enable orientation of their ends in adjoining fashion in the supporting posts without overlap.

Substantially horizontal inner reinforcement flange 97 may be positioned along the substantially vertical outer shoulder of weight-supporting crossbeam 60 nearer top 102 than bottom 64 of weight-supporting crossbeam 60, as shown in FIGS. 2, 3, 16, 17 and 44. Thus, when shelf 55 is placed on substantially horizontal inner reinforcement flange 97 of weight-supporting crossbeam 60, the substantially vertical outer shoulders and substantially horizontal inner reinforcement flanges 97 operably and telescopically receive and support shelf 55 in a shelf retention cavity. Once placed on substantially horizontal inner reinforcement flange 97, shelf 55 will be flush with, or extend beyond, top 102 of weight-supporting crossbeam 60 such that any item placed on shelf 55 can be slid away and off of the shelving system without first having to lift the item above top 102 of weight-supporting crossbeam 60. This type of shelving system orientation may be beneficial for storing heavy objects or other items that would be difficult to gain access to and lift above top 102 of weight-supporting crossbeam 60. The design of weight-supporting crossbeam 60, when inverted, results in a tray, with edges formed by the vertical outer shoulders, when shelf 55 is placed on substantially horizontal inner reinforcement flange 97 of weight-supporting crossbeam 60, as shown in FIG. 45. Because vertical outer shoulder portion 96 can extend beyond the height of shelf 55, upon inversion of cross beam 60, shelf 55 and weight-supporting crossbeam 60, in combination, act as a tray to prevent items from falling off shelf 55. This type of shelving system orientation may be beneficial for storing smaller objects that have a tendency to roll around, or otherwise be unstable, on shelf 55.

Alternatively, substantially horizontal inner reinforcement flange 97 of weight-supporting crossbeam 60 may be positioned along the substantially vertical outer shoulder of the weight-supporting crossbeam 60 equidistant from top 102 and bottom 64. The symmetry achieved by positioning substantially horizontal inner reinforcement flange 97 in this manner prevents assembler error of the shelving system. In other words, both possible orientations of weight-supporting crossbeam 60 will still result in a fully functioning shelving system 50. Substantially horizontal inner reinforcement flange 97 of weight-supporting crossbeam 60 may have holes 100 positioned in substantially horizontal inner reinforcement flange 97 proximate to the ends of weight-supporting crossbeam 60. Holes 100 may serve varying purposes. For example, holes 100 permit weight-supporting crossbeam 60 to be hung from a hook for purposes of coating weight-supporting crossbeam 60 with a suitable coating. Alternatively, holes 100 permit the insertion of restraint post 103 to secure weight-supporting crossbeam 60 to shelves 55, as shown in FIG. 45. One of ordinary skill in the art will understand that holes 100 may serve other purposes as well and that restraint post 103 may be any suitable post, including, for example, a screw, a nail, a bolt, a dowel, etc.

Weight-supporting crossbeam 60 also has one or more beam attachment members 90, 91, 92, and 93, e.g., pegs or rivets, affixed to the substantially vertical outer shoulder of weight-supporting crossbeam 60. In the embodiment shown in FIGS. 2, 3, and 4, pegs 90 and 92 are positioned on upper outer shoulder portion 95 of weight-supporting crossbeam 60 and pegs 91 and 93 are positioned on lower outer shoulder portion 96 of weight-supporting crossbeam 60. One or more beam attachment members 90, 91, 92, and 93 permit weight-supporting crossbeam 60 to attach to crossbeam-supporting posts 51 when assembling shelving system 50. One or more beam attachment member 90, 91, 92, and 93 can be attached to weight-supporting crossbeam 60 in any suitable fashion. For example, FIG. 17 shows beam attachment members 90 and 91 attached to weight-supporting crossbeam 60 via rivets 90a and 91a.

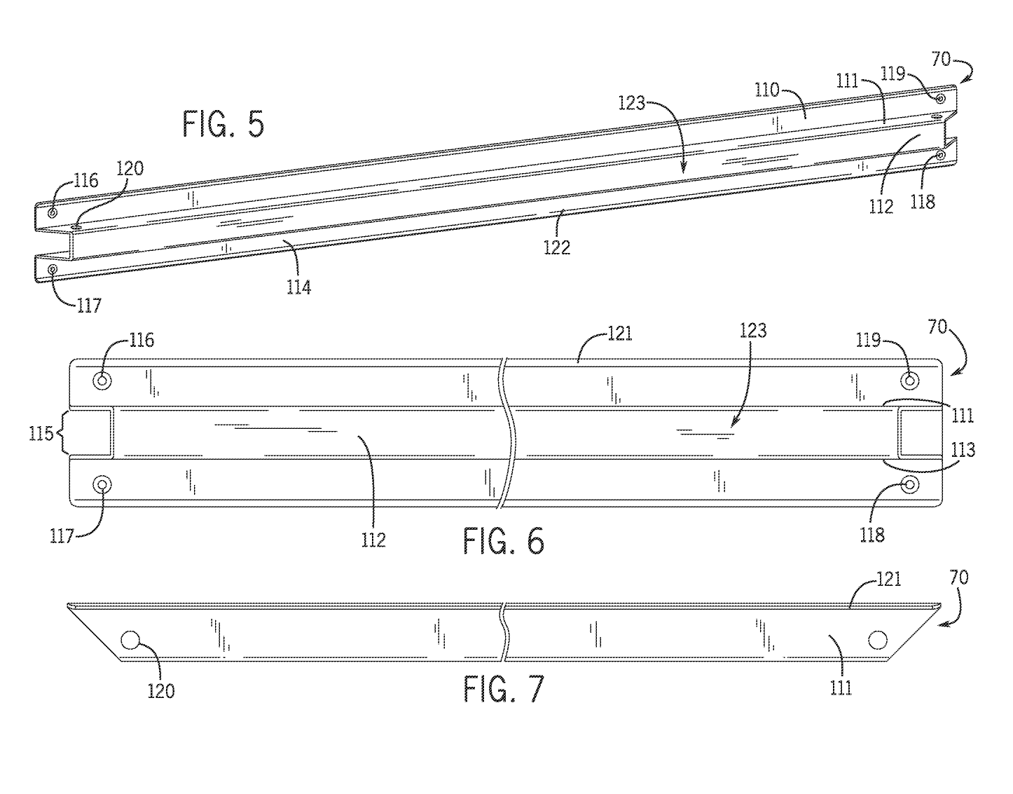

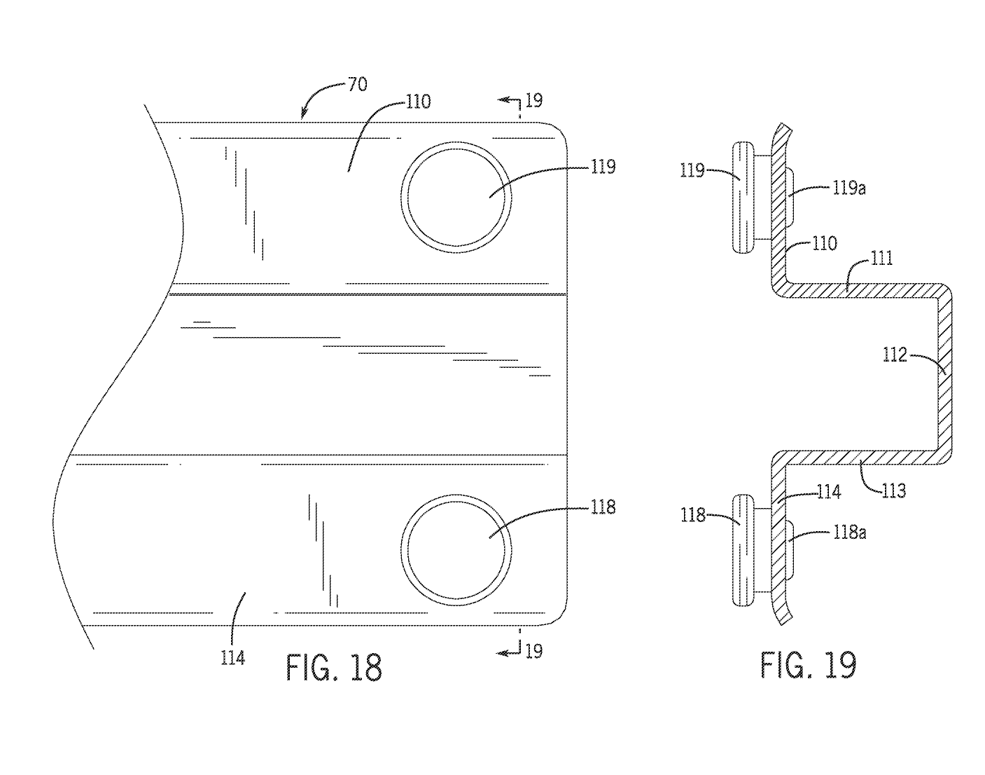

Referring now to FIGS. 5, 6, 7, 18, and 19, another embodiment of weight-supporting crossbeam 70 is shown. Weight-supporting crossbeam 70 has substantially horizontal inner reinforcement flange 123 comprised of upper horizontal flange segment 111, lower horizontal flange segment 113 and vertical flange segment insert 112 that connects upper horizontal flange segment 111 and lower horizontal flange segment 113 to form a flange channel 115. Substantially horizontal inner reinforcement flange 123 of weight-supporting crossbeam 70 is positioned along a substantially vertical outer shoulder comprised of upper outer shoulder portion 110 and lower outer shoulder portion 114 of weight-supporting crossbeam 70 between top 121 and bottom 122 of weight-supporting crossbeam 70. Substantially horizontal inner reinforcement flange 123 may be positioned anywhere along the outer shoulder of the weight-supporting crossbeam 70.

Substantially horizontal inner reinforcement flange 123 may be positioned along the substantially vertical outer shoulder of weight-supporting crossbeam 70 equidistant from top 121 and bottom 122, as shown in FIGS. 5, 6, 7, 18 and 19. Thus, when shelf 55 is placed on substantially horizontal inner reinforcement flange 123 of weight-supporting crossbeam 70, shelf 55 will be flush with, or extend beyond, top 121 of the weight-supporting crossbeam 70 such that any item placed on shelf 55 can be slid away and off of the shelving system without first having to lift the item above top 121 of weight-supporting crossbeam 70. As with beam 60, this type of orientation may be beneficial for storing heavy objects or other items that would be difficult to gain access to and lift above top 121 of weight-supporting crossbeam 70. Moreover, the symmetry achieved by positioning the substantially horizontal inner reinforcement flange in this manner prevents assembler error of the shelving system. In other words, both possible orientations of weight-supporting crossbeam 70 will still result in a functioning shelving system.

Alternatively, substantially horizontal inner reinforcement flange 123 may be positioned nearer bottom 122 than top 121 of weight-supporting crossbeam 70. When substantially horizontal inner reinforcement flange 123 is positioned nearer bottom 122 than top 121 of weight-supporting crossbeam 70, shelf 55 laying upon substantially horizontal inner reinforcement flange 123 would not extend beyond top 121 of weight-supporting crossbeam 70, and shelf 55 and shoulder portion 110 or 114 of vertical weight-supporting crossbeam 70, in combination, serves to position edges about shelf 55 to convert it to a tray, to prevent items from falling off the shelf. This type of shelving system orientation may be beneficial for storing smaller objects that have a tendency to roll around, or otherwise be unstable, on shelf 55.

As with crossbeam 60, substantially horizontal inner reinforcement flange 123 of weight-supporting crossbeam 70 may have holes 120 positioned proximate to the ends of weight-supporting crossbeam 70—for both fabrication purposes, for enabling crossbeam 70 to be hung from a hook, or hooks, for storage purposes, as well as to stabilize a shelf positioned within the crossbeams. One of ordinary skill in the art will understand that holes 120 may serve other purposes as well.

Weight-supporting crossbeam 70 also has one or more beam attachment members 116, 117, 118, and 119, e.g., pegs or rivets, affixed to the substantially vertical outer shoulder of weight-supporting crossbeam 70. In the embodiment shown in FIGS. 5, 6, and 7, pegs 116 and 119 are positioned on upper outer shoulder portion 110 of weight-supporting crossbeam 70 and pegs 117 and 118 are positioned on lower outer shoulder portion 114 of weight-supporting crossbeam 70. One or more beam attachment members 116, 117, 118, and 119 permit weight-supporting crossbeam 70 to attach to crossbeam-supporting posts 51 when assembling shelving system 81. One or more beam attachment member 116, 117, 118, and 119 can be attached to weight-supporting crossbeam 70 in any suitable fashion. For example, FIG. 19 shows beam attachment members 118 and 119 attached to weight-supporting crossbeam 70 via rivets 118a and 119a.

One of ordinary skill in the art will appreciate that various other modifications may be made to weight-supporting crossbeams 60 and 70, including the location and geometry of their respective substantially horizontal inner reinforcement flanges, without departing from the spirit or scope of the disclosure.

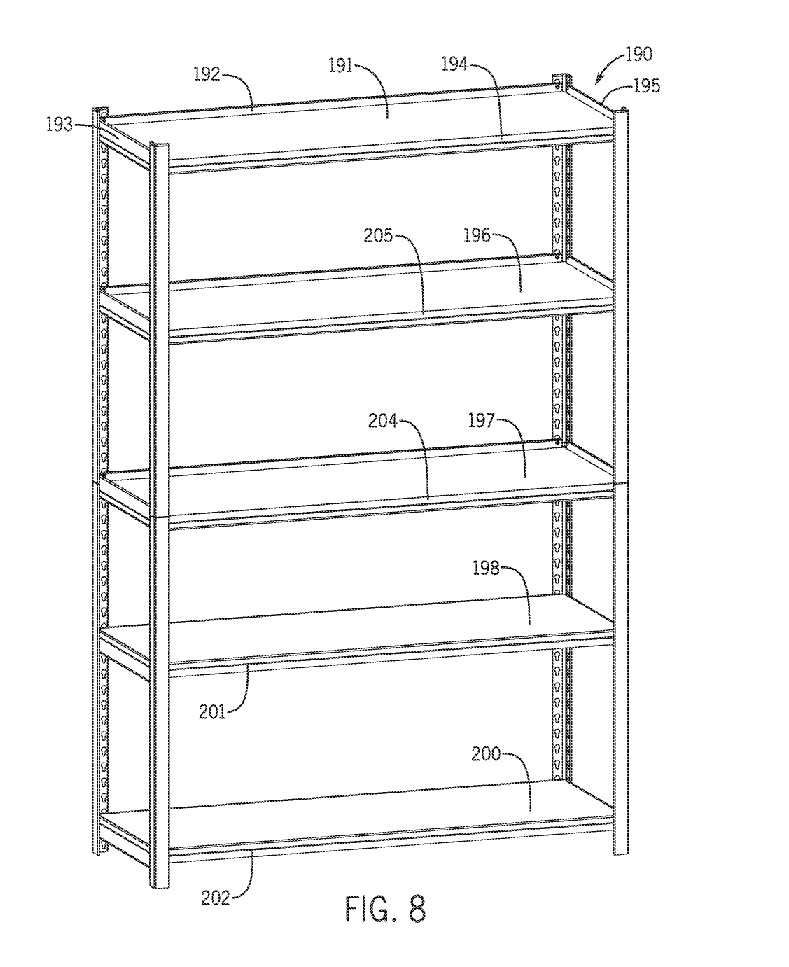

Referring now to FIG. 8, shelving system 190 is shown including indented, weight-supporting crossbeams 194, 201, 202, 204, and 205, non-indented weight-supporting crossbeams 192, 193 and 195, and shelves 191, 196, 197, 198, and 200. Indented, weight supporting crossbeam 194 and non-indented, weight-supporting crossbeams 192, 193, and 195 combine to form a substantially U-shaped periphery about shelf 191. An item may be slid off of shelf 191 via the indent of indented, weight-supporting crossbeam 194. That item is prevented from sliding off of shelf 191 due to non-indented, weight-supporting crossbeams 192, 193, and 195. Shelves 198 and 200 are supported, in part, by inverted, indented, weight-supporting crossbeam 201 and 202, respectively. Items can be slid off of shelves 198 and 200 from any side of those shelves.

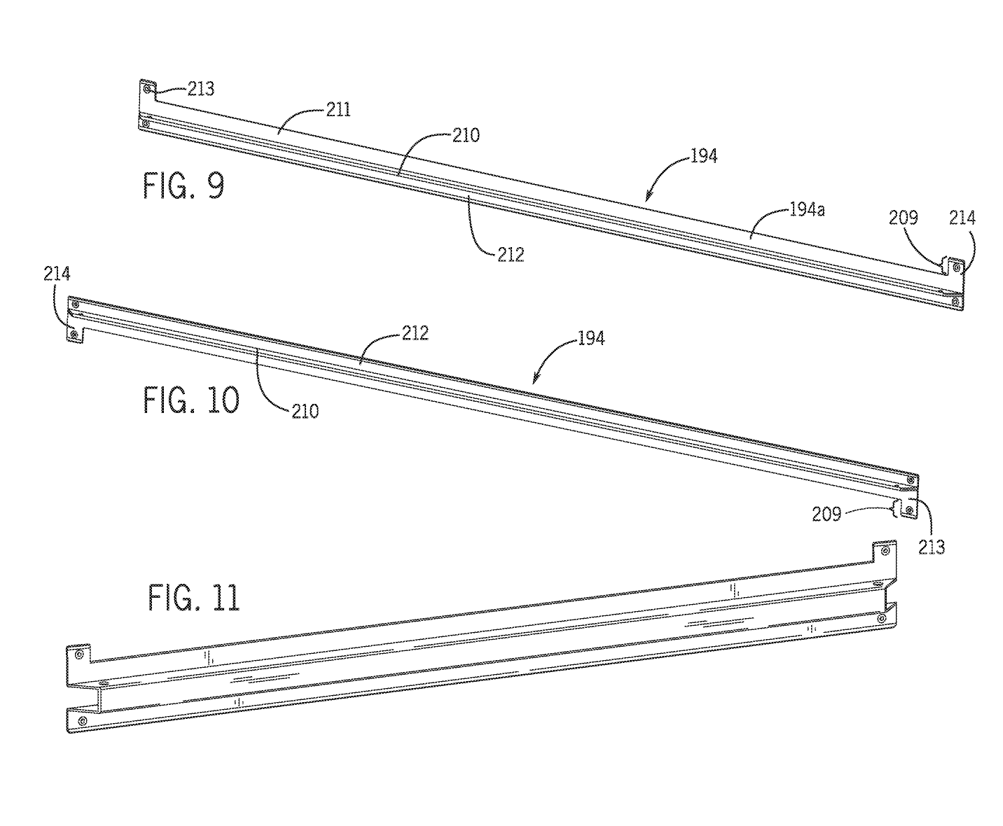

Referring now to FIGS. 9 and 10, another embodiment of weight-supporting crossbeam 194 is shown. Weight-supporting crossbeam 194 includes substantially horizontal inner reinforcement flange 210. In this embodiment, substantially horizontal inner reinforcement flange 210 is identical to substantially horizontal inner reinforcement flange 97 of weight-supporting crossbeam 60. Substantially horizontal inner reinforcement flange 210 of weight-supporting crossbeam 194 is positioned along a substantially vertical outer shoulder comprised of upper outer shoulder portion 211 and lower outer shoulder portion 212 of weight-supporting crossbeam 194. Substantially horizontal inner reinforcement flange 210 may be positioned anywhere along the substantially vertical outer shoulder of weight-supporting crossbeam 194. Upper outer shoulder portion 211 of weight-supporting crossbeam 194 includes indent 209, such that weight-supporting crossbeam 194 is an indented, weight-supporting crossbeam. In this particular embodiment, indent 209 does not extend to ends 213 and 214 of indented, weight-supporting crossbeam 194. In this way, indented, weight-supporting crossbeam 194 can have one or more beam attachment members affixed to ends 213 and 214 that, in turn, affix to suitable post attachment members of the crossbeam-supporting posts when assembling shelving system 190.

Indented, weight-supporting crossbeam 194 may be used in conjunction with additional, weight-supporting crossbeams 194, inverted, as shown in FIG. 10, in shelving system 190. By combining indented, weight-supporting crossbeam 194 with three, inverted, weight-supported crossbeams 60, the shelving system permits items to slide off of one edge of shelf 191 through indent 209—without having to lift the item up and over upper outer shoulder portion 211, while simultaneously preventing the item from sliding to slide off shelf 191 due to lower outer shoulder portions 96 of weight-supporting crossbeam 60, as inverted.

Those of ordinary skill in the art will appreciate that many weight-supporting crossbeam embodiments can also be modified with an indent to permit items stored on the shelves to slide easily off of only one edge of the shelf, including weight-supporting crossbeam 70, as modified with an indent, as shown in FIG. 11.

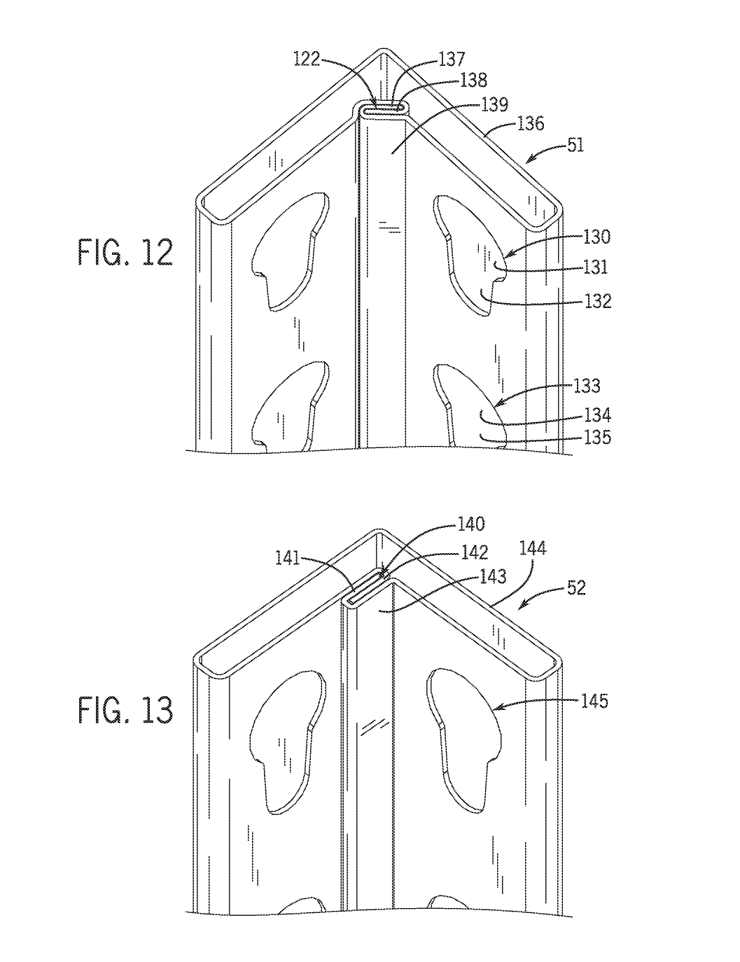

Referring now to FIG. 12, FIG. 12 shows continuously tubular, V-shaped crossbeam-supporting post 51. Continuously tubular, V-shaped crossbeam-supporting post 51 is made of post material 136, which, preferably is made of a suitable, shaped steel material. Material 136 can be any suitable material that has the proper strength and rigidity characteristics necessary to support the weight of weight-supporting crossbeams 60 and/or 70, shelves 55, and any items placed onto shelves 55. Material 136 is bent into continuously tubular, V-shaped crossbeam-supporting post 51 shape and secured by crimping first end 137 of material 136 and second end 138 of material 136, forming crimp 122 and crimp face 139 along a vertical axis of continuously tubular, V-shaped crossbeam-supporting post 51. Continuously tubular, V-shaped crossbeam-supporting post 51 creates a closed cavity region having an uninterrupted peripheral cross-section when continuously tubular, V-shaped crossbeam-supporting post 51 is viewed in perspective, as in FIG. 12. The continuously tubular, V-shape of continuously tubular, V-shaped crossbeam-supporting post 51 has beneficial strength, rigidity, and deflection characteristics.

Continuously tubular, V-shaped crossbeam-supporting post 51 also has one or more post attachment members 130 and 133, e.g., keys, shaped and spaced for mated affixation to one or more beam attachment members 90, 91, 92, and 93 and 116, 117, 118, and 119 of weight-supporting crossbeams 60 and 70, respectively, such that weight-supporting crossbeams 60 or 70 can operably, restrainably, and removably fasten to continuously tubular, V-shaped crossbeam-supporting post 51. One or more post attachment members 130 and 133 are comprised of upper lobes 131 and 134, respectively, and lower lobes 132 and 135, respectively. To attach the beam attachment members to the post attachment members, adjacent beam attachment members 92 and 116 are inserted into adjacent upper lobes 131 and 134, respectively, and slid downwardly into lower lobes 132 and 135, respectively. Post attachment members 130 and 133 are generally positioned on the portions of material 136 that lie adjacent to crimp face 139 of continuously tubular, V-shaped crossbeam-supporting post 51.

Referring now to FIG. 13, FIG. 13 shows continuously tubular, V-shaped crossbeam-supporting post 52. Continuously tubular, V-shaped crossbeam-supporting post 52 is made of material 144. Material 144 is bent into a continuously tubular, V-shape and secured by crimping first end 141 of material 144 and second end 142 of material 144, forming crimp 140 and crimp face 143 along a vertical axis of continuously tubular, V-shaped crossbeam-supporting post 52. As in other embodiments, material 144 can be of any suitable material that has the proper strength and rigidity characteristics necessary to support the weight of weight-supporting crossbeams 60 and/or 70, shelves 55, and any items placed onto shelves 55. Continuously tubular, V-shaped crossbeam-supporting post 52 creates a closed cavity region having an uninterrupted peripheral cross-section when continuously tubular, V-shaped crossbeam-supporting post 52 is viewed in cross-section, as in FIG. 13. The continuously tubular, V-shape of continuously tubular, V-shaped crossbeam-supporting post 52 likewise has beneficial strength, rigidity, and deflection characteristics.

Continuously tubular, V-shaped crossbeam-supporting post 52 also has one or more post attachment members 145, e.g., keys, shaped and spaced for mated affixation to one or more beam attachment members 90, 91, 92, and 93 and 116, 117, 118, and 119 of weight-supporting crossbeams 60 and 70, respectively, such that weight-supporting crossbeams 60 or 70 can operably and restrainably fasten to continuously tubular, V-shaped crossbeam-supporting post 52. Post attachment members 145 are generally positioned on the portions of material 144 that lie adjacent to crimp face 143 of continuously tubular, V-shaped crossbeam-supporting post 52.

One of ordinary skill in the art will understand that crimp styles and locations other than those of continuously tubular, V-shaped crossbeam-supporting posts 51 and 52 are within the scope of the disclosure.

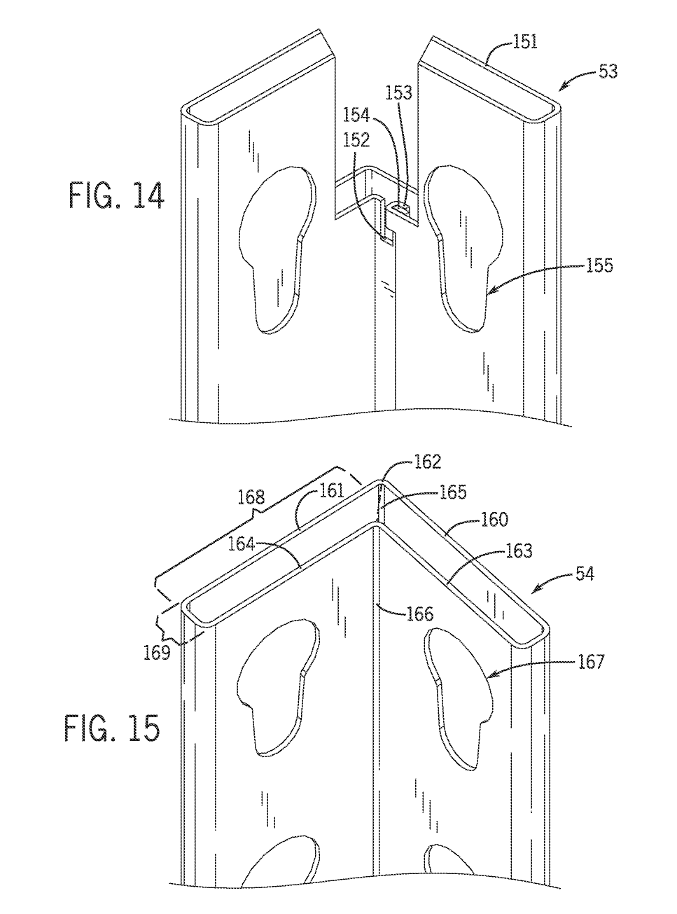

Referring now to FIG. 14, FIG. 14 shows yet another embodiment of continuously tubular, V-shaped crossbeam-supporting post 53. Continuously tubular, V-shaped crossbeam-supporting post 53 is made of material 151, which is bent into the peripheral shape of continuously tubular, V-shaped crossbeam-supporting post 53 and is secured by bending hook 153 around notch 154 of cavity 152, i.e., a hook and notch assembly. Likewise, material 144 can be any suitable material that has the proper strength and rigidity characteristics necessary to support the weight of weight-supporting crossbeams 60 and/or 70, shelves 55, and any items placed onto shelves 55. Continuously tubular, V-shaped crossbeam-supporting post 53 creates a closed cavity region having an uninterrupted peripheral cross-section when continuously tubular, V-shaped crossbeam-supporting post 53 is viewed in cross-section, as in FIG. 14. The continuously tubular, V-shape of continuously tubular, V-shaped crossbeam-supporting post 53 has beneficial strength, rigidity, and deflection characteristics.

One of ordinary skill in the art will understand that the locations of hook 153 and corresponding notch 154 may be switched or otherwise altered without departing from the spirit or scope of the disclosure. One of ordinary skill in the art will appreciate that many different hook and notch assembly configurations are possible and will accomplish the same purpose of securing continuously tubular, V-shaped crossbeam-supporting post 53.

Continuously tubular, V-shaped crossbeam-supporting post 53 also has one or more post attachment members 155, e.g., keys, shaped and spaced for mated affixation to one or more beam attachment members 90, 91, 92, and 93 and 116, 117, 118, and 119 of weight-supporting crossbeams 60 and 70, respectively, such that weight-supporting crossbeams 60 or 70 can operably and restrainably fasten to continuously tubular, V-shaped crossbeam-supporting post 53.

Referring now to FIG. 15, FIG. 15 shows continuously tubular, V-shaped crossbeam-supporting post 54. Continuously tubular, V-shaped crossbeam-supporting post 54 has first exterior wall 161 and first interior wall 164. Width portion 169 defines the thickness of continuously tubular, V-shaped crossbeam-supporting post 54 and spans between first exterior wall 161 and first interior wall 164. Length portion 168 defines the diagonal midpoint length of first exterior wall 161 of one of the two post legs of continuously tubular, V-shaped crossbeam-supporting post 54. Advantageously, the length portion 168 to width portion 169 ratio of continuously tubular, V-shaped crossbeam-supporting post 54 ranges between approximately 4 to 6. Continuously tubular, V-shaped crossbeam-supporting post 54 also has second exterior wall 160 and second interior wall 163. Exterior corner 162 of continuously tubular, V-shaped crossbeam-supporting post 54 connects first exterior wall 161 and second exterior wall 160. Interior corner 166 of continuously tubular, V-shaped crossbeam-supporting post 54 connects first interior wall 164 and second interior wall 163, thereby creating a closed cavity region having an uninterrupted peripheral cross-section when continuously tubular, V-shaped crossbeam-supporting post 54 is viewed in cross-section, as in FIG. 15. Exterior corner 162 may form exterior welded corner 165. Alternatively, in lieu of exterior welded corner 165, interior corner 166 may form an interior welded corner. The continuously tubular, V-shape of continuously tubular, V-shaped crossbeam-supporting post 54 has beneficial strength, rigidity, and deflection characteristics.

Continuously tubular, V-shaped crossbeam-supporting post 53, as with the other supporting post embodiments, also has one or more post attachment members 167, e.g., keys, shaped and spaced for mated affixation to one or more beam attachment members 90, 91, 92, and 93 and 116, 117, 118, and 119 of weight-supporting crossbeams 60 and 70, respectively, such that weight-supporting crossbeams 60 or 70 can operably and restrainably fasten to continuously tubular, V-shaped crossbeam-supporting post 54.

One of ordinary skill in the art will understand that the angle formed by continuously tubular, V-shaped crossbeam-supporting posts 51, 52, 53 and 54 will vary depending the number of posts and crossbeams intended for use in a particular shelving system. For example, for a square or rectangular shelving system that utilizes four posts and four cross beams, the angle would be ninety degrees. For a shelving system in the shape of an equilateral triangle that utilizes three posts and three crossbeams, the angle would be sixty degrees.

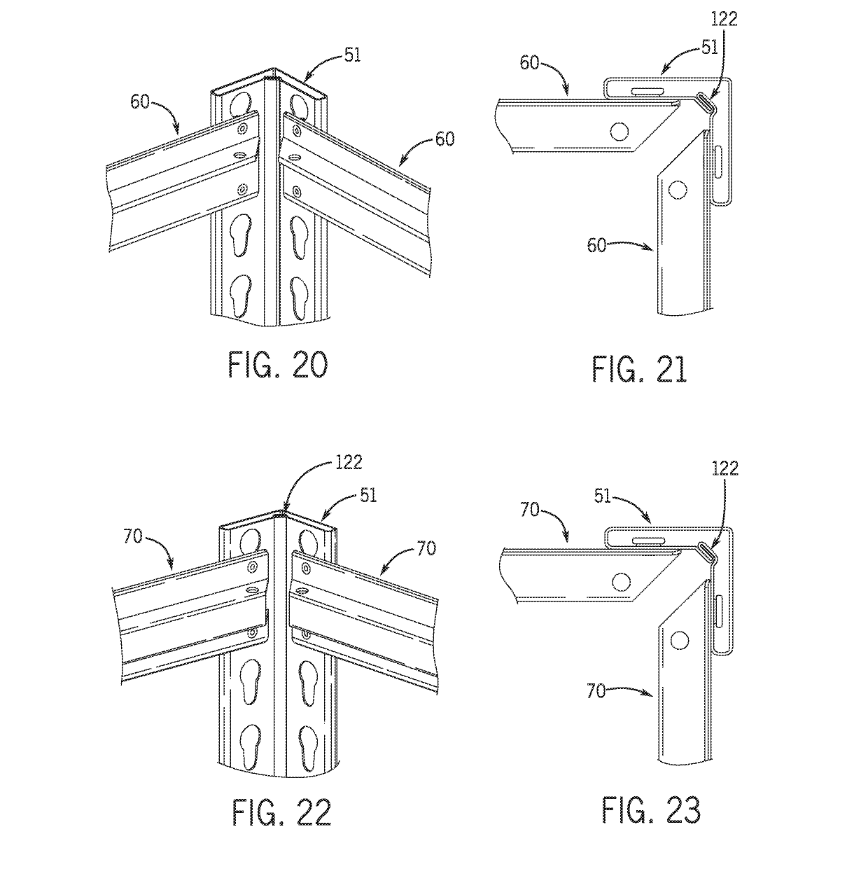

FIG. 20 is a perspective view of weight-supporting crossbeam 60 of FIG. 2 affixed to continuously tubular, V-shaped crossbeam-supporting post 51. FIG. 21 is a top plan view of weight-supporting crossbeam 60 affixed to continuously tubular, V-shaped crossbeam-supporting post 51. FIGS. 20 and 21 provide a clear view of crimp 122, which secures the continuously tubular V-shaped crossbeam-supporting post's shape.

FIG. 22 is a perspective view of weight-supporting crossbeam 70 affixed to continuously tubular, V-shaped crossbeam-supporting post 51. FIG. 23 is a top plan view of weight-supporting crossbeam 70 affixed to continuously tubular, V-shaped crossbeam-supporting post 51. FIGS. 22 and 23 provide a clear view of crimp 122, which secures the continuously tubular V-shaped crossbeam-supporting post's shape.

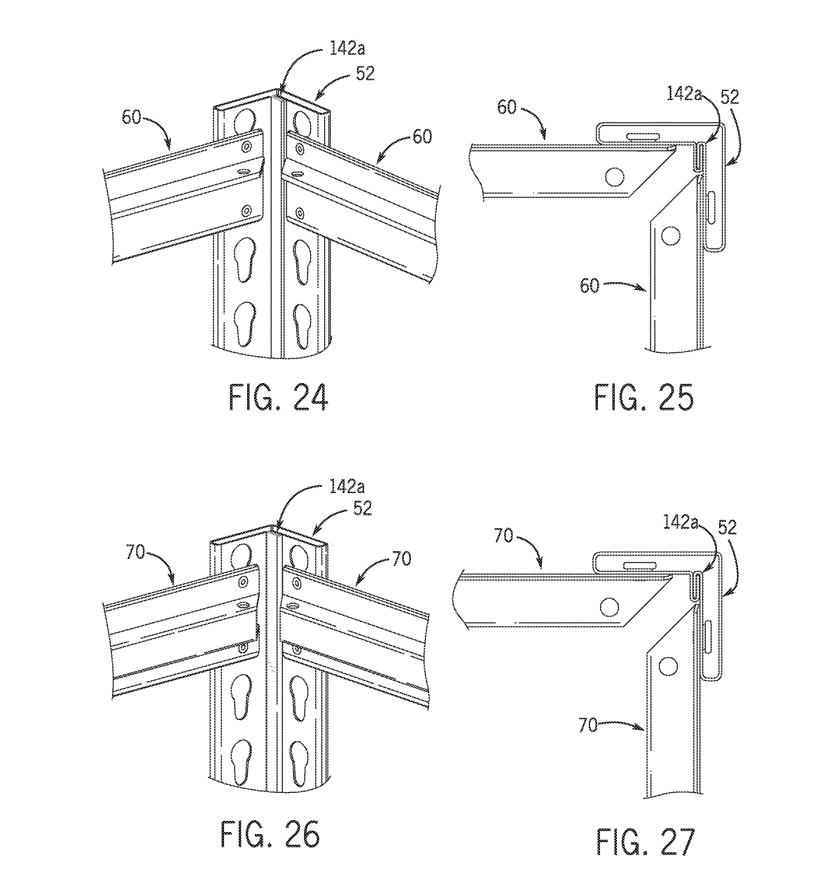

FIG. 24 is a perspective view of weight-supporting crossbeam 60 affixed to continuously tubular, V-shaped crossbeam-supporting post 52, as modified by moving the position of the crimp ninety degrees. FIG. 25 is a top plan view of weight-supporting crossbeam 60 affixed to continuously tubular, V-shaped crossbeam-supporting post 52, as modified by moving the position of the crimp ninety degrees. FIGS. 24 and 25 provide a clear view of crimp 142a, which is located in the reverse position of crimp 142 (as shown in FIG. 13) and which secures the continuously tubular V-shaped crossbeam-supporting post's shape.

FIG. 26 is a perspective view of weight-supporting crossbeam 70 affixed to continuously tubular, V-shaped crossbeam-supporting post 52, as modified by moving the position of the crimp ninety degrees. FIG. 27 is a top plan view of weight-supporting crossbeam 70 affixed to continuously tubular, V-shaped crossbeam-supporting post 52, as modified by moving the position of the crimp ninety degrees. FIGS. 26 and 27 provide a clear view of crimp 142a, which is located in the reverse position of crimp 142 (as shown in FIG. 13) and which secures the continuously tubular V-shaped crossbeam-supporting post's shape.

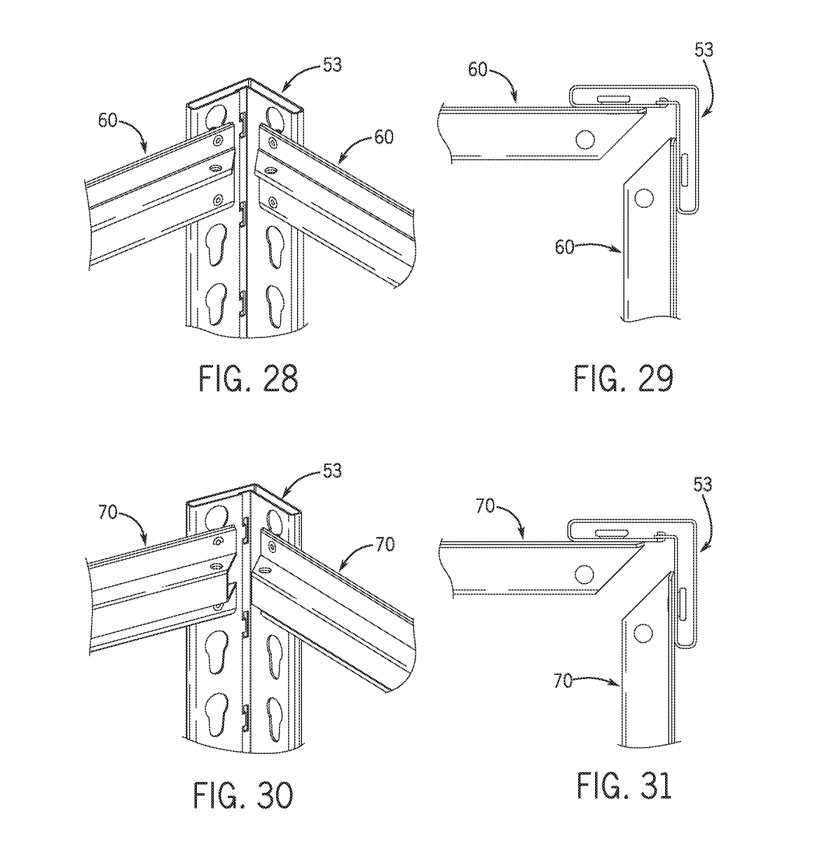

FIG. 28 is a perspective view of weight-supporting crossbeam 60 affixed to continuously tubular, V-shaped crossbeam-supporting post 53, as modified by moving the position of the hook and notch assembly ninety degrees. FIG. 29 is a top plan view of weight-supporting crossbeam 60 affixed to continuously tubular, V-shaped crossbeam-supporting post 53, as modified by moving the position of the hook and notch assembly ninety degrees.

FIG. 30 is a perspective view of weight-supporting crossbeam 70 affixed to continuously tubular, V-shaped crossbeam-supporting post 53, as modified by moving the position of the hook and notch assembly ninety degrees. FIG. 31 is a top plan view of weight-supporting crossbeam 70 affixed to continuously tubular, V-shaped crossbeam-supporting post 53, as modified by moving the position of the hook and notch assembly ninety degrees.

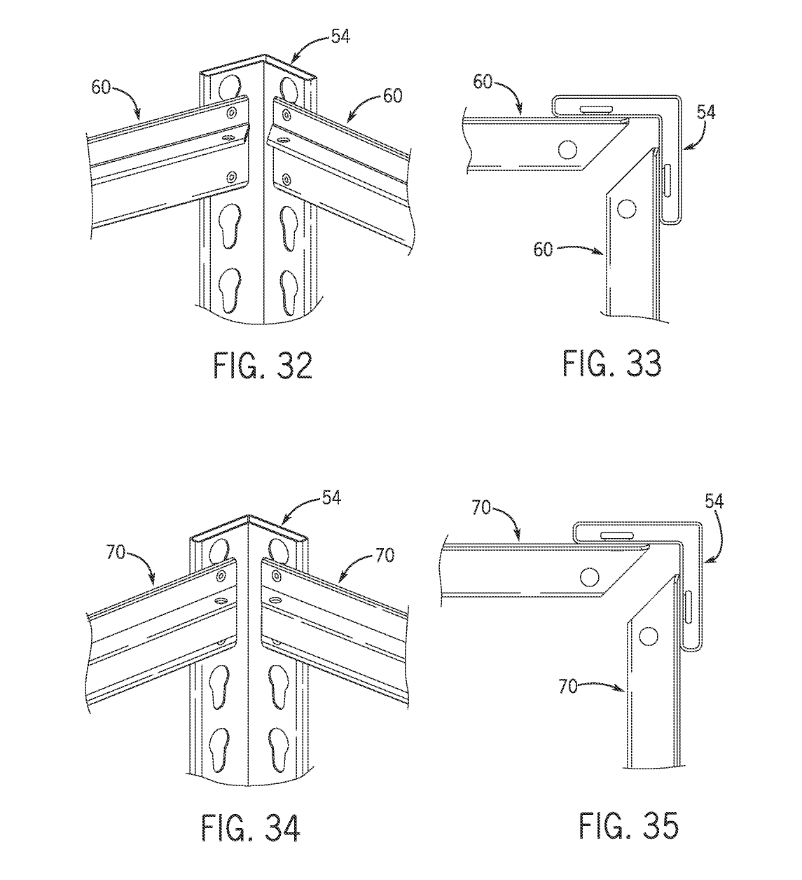

FIG. 32 is a perspective view of weight-supporting crossbeam 60 affixed to continuously tubular, V-shaped crossbeam-supporting post 54. FIG. 33 is a top plan view of weight-supporting crossbeam 60 affixed to continuously tubular, V-shaped crossbeam-supporting post 54.

FIG. 34 is a perspective view of weight-supporting crossbeam 70 affixed to continuously tubular, V-shaped crossbeam-supporting post 54. FIG. 35 is a top plan view of weight-supporting crossbeam 70 affixed to continuously tubular, V-shaped crossbeam-supporting post 54.

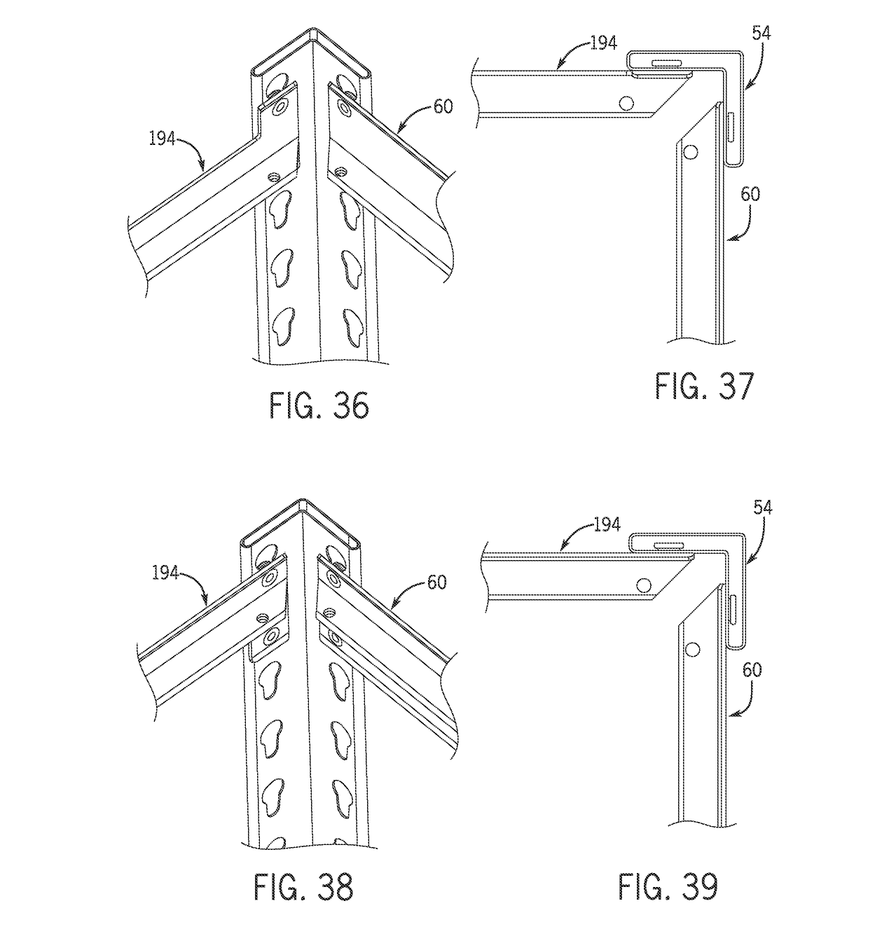

FIG. 36 is a perspective view of indented, weight-supporting crossbeam 194 and weight-supporting crossbeam 60, inverted, affixed to the continuously tubular, V-shaped crossbeam-supporting post 54. FIG. 37 is a top plan view of indented, weight-supporting crossbeam 194 and weight-supporting crossbeam 60, inverted, affixed to continuously tubular, V-shaped crossbeam-supporting post 54.

FIG. 38 is a perspective view of indented, weight-supporting crossbeam 194, inverted, and weight-supporting crossbeam 60 affixed to continuously tubular, V-shaped crossbeam-supporting post 54. FIG. 39 is a top plan view of indented, weight-supporting crossbeam 194, inverted, and weight-supporting crossbeam 60 affixed to continuously tubular, V-shaped crossbeam-supporting post 54.

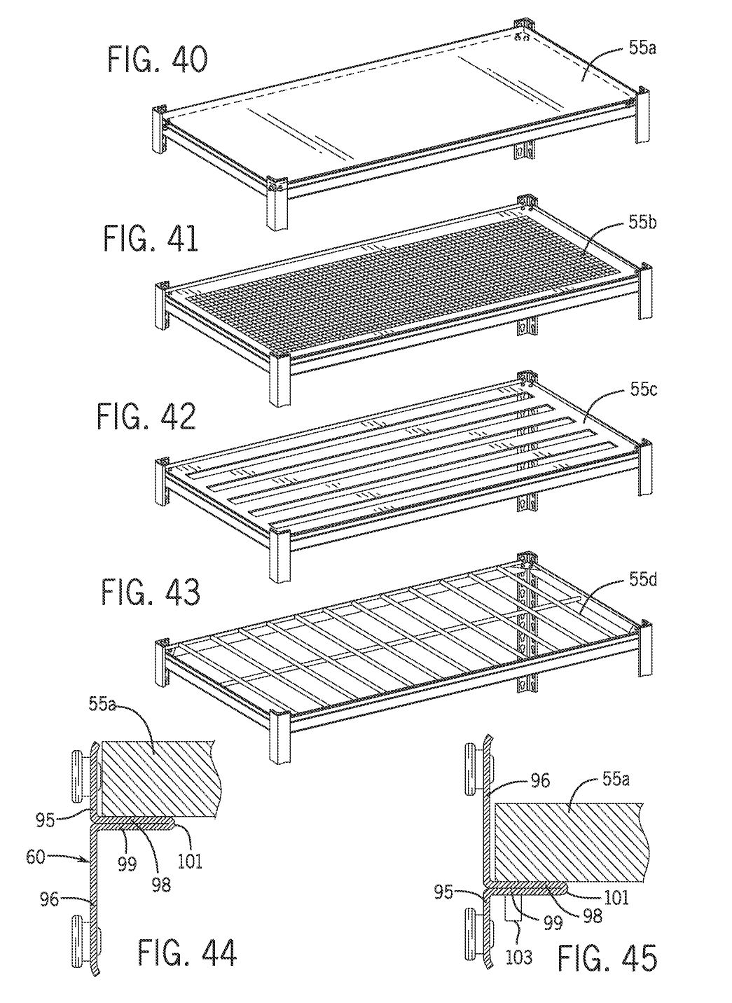

Referring to FIGS. 40, 41, 42, and 43 a variety of shelves 55 may be used in shelving system 50. For example, shelf 55 may be substantially planar, solid shelf 55a. Substantially planar, solid shelf 55a would be suitable for supporting large, heavy objects. Alternatively, shelf 55 may be substantially planar, grated shelf 55b. Substantially planar, grated shelf 55b would perhaps be suitable for supporting round objects in order to prevent movement of such round objects about substantially planar, grated shelf 55b. Shelf 55 may also be substantially planar, slotted rack 55c, while, shelf 55 may also be substantially planar, wire rack 55d. Substantially planar, solid shelf 55a, substantially planar, grated shelf 55b, substantially planar, slotted rack 55c, and substantially planar, wire rack 55d can, but need not, be used in combination with one another in a particular shelving system. Although FIGS. 40, 41, 42, and 43 all show their respective substantially planar, solid shelf 55a, substantially planar, grated shelf 55b, substantially planar, slotted rack 55c, and substantially planar, wire rack 55d as being supported by all four weight-supporting beams, one of ordinary skill in the art will appreciate that less than all weight-supporting crossbeams for a particular shelving system are required to support substantially planar, solid shelf 55a, substantially planar, grated shelf 55b, substantially planar, slotted rack 55c, and substantially planar, wire rack 55d. Generally, shelf 55 (including, for example, substantially planar, solid shelf 55a, substantially planar, grated shelf 55b, substantially planar, slotted rack 55c, and substantially planar, wire rack 55d) will be positioned substantially parallel to supporting surface 83.

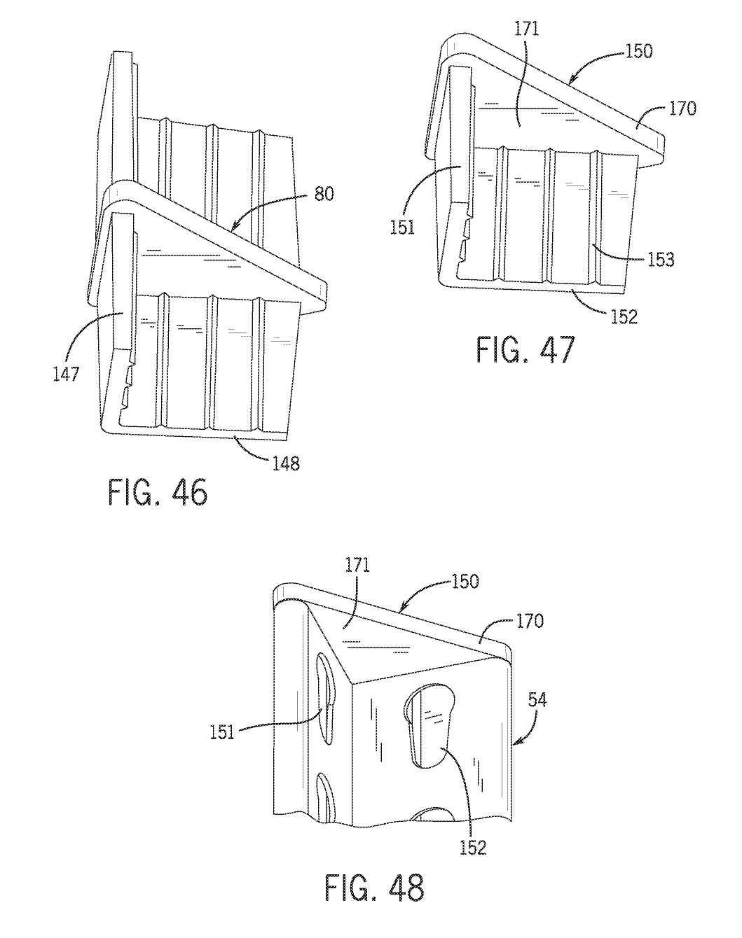

Another potential benefit of a continuously tubular vertical post design, including, without limitation, continuously tubular, V-shaped crossbeam-supporting posts 51, 52, 53, and 54, is that the posts can serve as a receptacle into which various functional shelving system components may be inserted. For example, as shown in FIG. 46, post coupling 80, with legs 147 and 148 may be inserted in the closed cavity regions of continuously tubular, V-shaped crossbeam-supporting posts 51 to connect post 51 to post 81. One of ordinary skill in the art will understand that post coupling 80 can be used to connect continuously tubular, V-shaped crossbeam-supporting posts 51, 52, 53, and/or 54. Referring now to FIGS. 47 and 48, post cap 150 can be inserted into continuously tubular, V-shaped crossbeam-supporting post 54 by inserting first cap leg 151 and second cap leg 152 into the closed cavity regions of continuously tubular, V-shaped crossbeam-supporting post 54. Post cap 150 is held in place by one or more ribs 153 that create a compression fit between post cap 150 and continuously tubular, V-shaped crossbeam-supporting post 54.

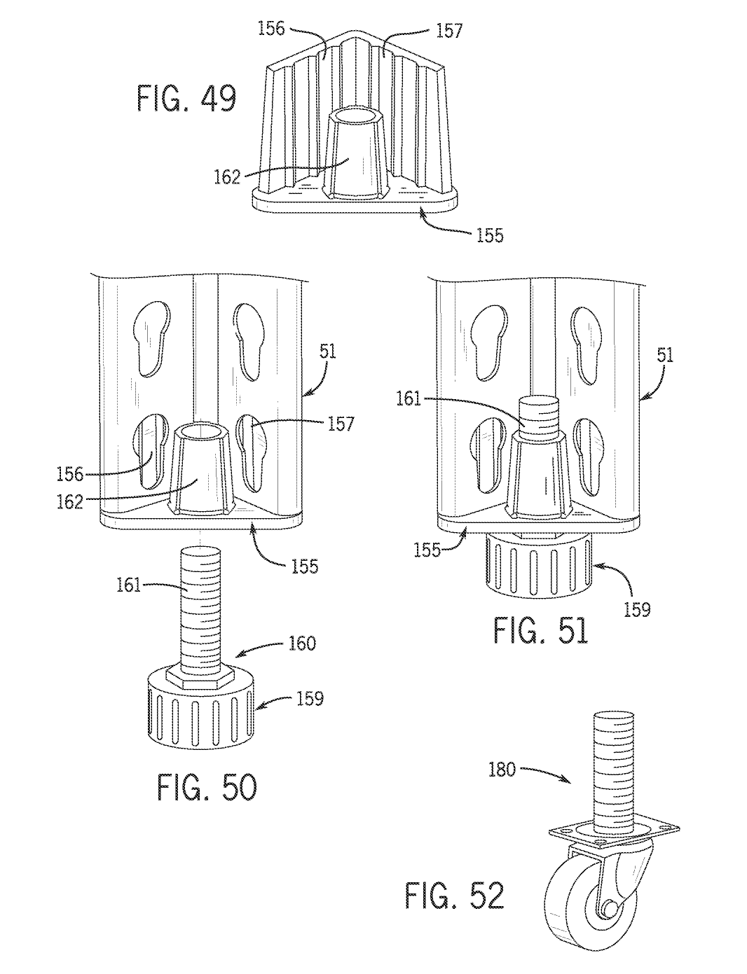

Referring now to FIGS. 49, 50, 51, and 52 leveler base cap 155 may be inserted into continuously tubular, V-shaped crossbeam-supporting post 51. Leveler base cap 155 has first leg 156 and second leg 157. Threaded cavity 162 protrudes from the center of leveler base cap 155 and can accept leveler 159 having threaded cylinder 161 designed to thread into threaded cavity 162. Leveler 159 may also have locknut 160 used to lock the location of leveler 159 when leveler 159 is threaded into threaded cavity 162. One leveler base cap assembly, comprised of a single leveler base cap 155, a single leveler 159, and, optionally locknut 160, would be needed for one or more of continuously tubular, V-shaped crossbeam-supporting posts 51 to properly level shelving system 81. The vertical position of each leveler 159 that is inserted into each continuously tubular, V-shaped crossbeam-supporting post 51 may be independently set depending on the surface geometry of supporting surface 83. In this way, shelving system 81 can be maintained in a level orientation on an uneven supporting surface 83. Other functional components may instead be inserted into continuously tubular, V-shaped crossbeam-supporting posts 51, 52, 53, and 54, including, for example, a wheel or caster assembly to enable movement of the shelving system, crossbeam-supporting post connectors used to stack multiple shelving posts on top of one another, etc. Caster 180, as shown in FIG. 52, could be threaded into leveler base cap 155 to form a caster assembly.

The foregoing description and drawings merely explain and illustrate the invention, and the invention is not so limited as those skilled in the art who have the disclosure before them will be able to make modifications and variations therein without departing from the scope of the invention.

We claim:

1. A shelving system comprising:
at least three weight-supporting crossbeams, each of the at least three weight-supporting crossbeams having two opposed ends and being capable of being positioned substantially parallel to a supporting surface to form a polygonal shape amongst the at least three weigh-supporting crossbeams once the ends are operably adjoined in succession in aligned beam support posts, each of the at least three weight-supporting crossbeams each having one or more beam attachment members for mated affixation to said aligned beam support posts;
said aligned beam support posts comprising at least three continuously tubular, V-shaped crossbeam-supporting posts emanating upwardly from the supporting surface, each of the at least three continuously tubular, V-shaped crossbeam-supporting posts being positioned at adjoining ends of the respective opposed ends of at least two of the at least three weight-supporting crossbeams,
each of the continuously tubular, V-shaped crossbeam-supporting posts being oriented substantially perpendicular to the supporting surface and each of the at least three weight-supporting crossbeams,
the at least three continuously tubular, V-shaped crossbeam-supporting posts having one or more post attachment members for mated affixation to respective ones of the beam attachment members in the at least three weight-supporting crossbeams enabling the at least three weight-supporting crossbeams to operably and restrainably fasten to the at least three continuously tubular, V-shaped crossbeam-supporting posts.

2. The shelving system according to claim 1 further comprising at least one shelf, the at least one shelf being supported in a position substantially parallel to the supporting surface by at least two of the at least three weight-supporting crossbeams.

3. The shelving system according to claim 2 wherein at least one of the at least three weight-supporting crossbeams comprises an indented, weight-supporting crossbeam.

4. The shelving system according to claim 2 wherein the at least one shelf is a substantially planar, solid shelf

5. The shelving system according to claim 2 wherein the at least one shelf is a substantially planar, grated shelf.

6. The shelving system according to claim 2 wherein the at least one shelf is a substantially planar, slotted rack.

7. The shelving system according to claim 2 wherein the at least one shelf is a substantially planar, wire rack.

8. The shelving system according to claim 2 wherein each of the at least three weight-supporting crossbeams have a substantially vertical outer shoulder and a substantially horizontal inner reinforcement flange positioned along the substantially vertical outer shoulder of each of the at least three weight-supporting crossbeams.

9. The shelving system according to claim 8 wherein the substantially horizontal inner reinforcement flanges are positioned equidistant from a top and a bottom of each of the at least three weight-supporting crossbeams.

10. The shelving system according to claim 9 wherein the substantially horizontal inner reinforcement flanges are positioned eccentrically from a top and a bottom of each of the at least three weight-supporting crossbeams.

11. The shelving system according to claim 8 wherein the at least one shelf rests on at least two of the substantially horizontal inner reinforcement flanges of at least two of the at least three weight-supporting crossbeams,
respective ones of the substantially vertical outer shoulders and horizontal inner reinforcement flanges operably and telescopically receiving and supporting the at least one shelf

12. The shelving system according to claim 11 wherein the substantially vertical outer shoulders and substantially horizontal inner reinforcement flanges of the adjoined weight-supporting crossbeams form a shelf retention cavity.

13. The shelving system according to claim 12 wherein the substantially horizontal inner reinforcement flange comprises upper and lower horizontal flange segments connected by a vertical flange segment to form a flange channel.

14. The shelving system according to claim 12 wherein the substantially horizontal inner reinforcement flange of each of the at least three weight-supporting crossbeams comprises a dual-thickness, horizontal flange folded back on itself

15. The shelving system according to claim 1 wherein the at least three weight-supporting crossbeams are invertible and restrainably attachable to respective ones of the at least three continuously tubular, V-shaped crossbeam-supporting posts.

16. The shelving system according to claim 1 wherein a crimp secures a first end and a second of each of the at least three continuously tubular V-shaped vertical crossbeam-supporting posts.

17. The shelving system according to claim 16 comprising four continuously tubular, V-shaped crossbeam-supporting posts.

18. The shelving system according to claim 1 wherein each of the at least three continuously tubular, V-shaped crossbeam-supporting posts define a substantially closed cavity region having an uninterrupted peripheral cross-section.

19. The shelving system according to claim 1 wherein the one or more post attachment members comprise one or more keys and the one or more beam attachment members comprise one or more pegs shaped and spaced for aligned insertion into respective ones of the one or more keys, the one or more pegs and the one or more keys enabling the at least three weight-supporting crossbeams to be operably and restrainably fastened to the at least three continuously tubular, V-shaped crossbeam-supporting posts.

20. The shelving system according to claim 1, wherein the invention further comprises one or more leveler assemblies inserted into one or more of the at least three continuously tubular, V-shaped crossbeam-supporting posts.

21. The shelving system according to claim 1, wherein the invention further comprises one or more caster assemblies inserted into one or more of the at least three continuously tubular, V-shaped crossbeam-supporting posts.

22. The shelving system according to claim 1, wherein the invention further comprises one or more post couplings insertable into one or more of the at least three continuously tubular, V-shaped crossbeam-supporting posts, to adjoin successive ones of said supporting posts in the longitudinal direction.

23. The shelving system according to claim 1 wherein a hook and notch assembly within one or more of the at least three continuously tubular, V-shaped crossbeam-supporting posts secures the peripheral shape of said continuously tubular, V-shaped crossbeam-supporting posts.

24. The shelving system according to claim 1 wherein one or more of the at least three continuously tubular, V-shaped crossbeam-supporting posts further comprise:
a first exterior wall and a first interior wall;
a second exterior wall and a second interior wall;
an exterior corner connecting the first exterior wall with the second exterior wall; and
an interior corner connecting the first interior wall with the second interior wall;
wherein, one of the exterior corner and the interior corner comprises a welded corner.

25. The shelving system according to claim 1 in which one or more of said at least three continuously tubular, V-shaped crossbeam-supporting posts comprises two post legs, each post leg having a width portion and a diagonal midpoint length portion, said length portion to width portion describing a ratio ranging from 4 to 6.

26. The shelving system according to claim 1 in which one or more of said at least three continuously tubular, V-shaped crossbeam-supporting posts comprises two post legs, each post leg having a width portion and a diagonal midpoint length portion, said length portion to width portion describing a ratio ranging from 4.5 to 5.5.
